(19) United States
(12) Patent Application Publication
(10) Pub. No.: US 2025/0096222 A1
(43) Pub. Date: Mar. 20, 2025

(54) SECONDARY BATTERY AND PREPARATION METHOD THEREOF

(71) Applicant: ZHEJIANG JINKO ENERGY STORAGE CO., LTD., Zhejiang (CN)

(72) Inventors: Lili CHEN, Zhejiang (CN); Zixiang YANG, Zhejiang (CN); Hanzhang SUN, Zhejiang (CN)

(21) Appl. No.: 18/945,351

(22) Filed: Nov. 12, 2024

(30) Foreign Application Priority Data
Sep. 27, 2024 (CN) 202411355018.3

(51) Int. Cl. H01M 4/04; H01M 10/0587

(52) U.S. Cl. CPC H01M 4/0404; H01M 4/0435; H01M 4/0471; H01M 10/0587

(57) ABSTRACT

Secondary battery and preparation method thereof are provided. Lithium source, iron source, phosphorus source, transition metal salt source, bismuth source, and solvent are mixed to obtain intermediate solution. PH of intermediate solution ranges from 1.0 to 4.0. Intermediate solution is subjected to hydrothermal reaction, to obtain precursor by drying. Precursor is subjected to heat treatment to obtain core. Core includes lithium iron phosphate and bismuth salt. Core is coated with coating material to obtain cathode material. Cathode material includes core and conductive polymer coating layer arranged on at least surface of core. Finally, cathode material is prepared into secondary battery. Cathode material in present disclosure has advantages of high compaction density and high conductivity, which can significantly enhance energy density, cycle performance, and high-and-low temperature performance when cathode material is applied to secondary battery.

### CROSS-REFERENCE TO RELATED APPLICATIONS

The present application claims priority to Chinese Patent Application No. 202411355018.3, filed on Sep. 27, 2024, the content of which is incorporated herein by reference in its entirety.

### TECHNICAL FIELD

The present disclosure relates to the technical field of secondary batteries, and in particular, to a secondary battery and a preparation method thereof.

### BACKGROUND

Lithium iron phosphate has attracted widespread attention since it was proposed in 1997, which occupies a place in cathode materials of secondary batteries due to excellent stability, high-rate charging, non-toxicity, and a long cycle life. However, the lithium iron phosphate also has obvious shortcomings, such as poor high-and-low temperature performance and low tap density, which limits further widespread application of the lithium iron phosphate to the cathode materials.

Therefore, how to prepare lithium iron phosphate materials with good high-and-low temperature performance, a high capacity, and excellent cycle performance is the technical focus in the art.

### SUMMARY

In order to overcome the above shortcomings, the present disclosure provides a secondary battery and a preparation method thereof, which can improve energy density, cycle performance, and high-and-low temperature performance of cathode materials.

In a first aspect, some embodiments of the present disclosure provide a secondary battery, including the following steps:
mixing a lithium source, an iron source, a phosphorus source, a transition metal salt source, a bismuth source, and a solvent to obtain an intermediate solution, a pH of the intermediate solution ranging from 1.0 to 4.0;
subjecting the intermediate solution to a hydrothermal reaction, to obtain a precursor by drying;
subjecting the precursor to heat treatment to obtain a core, the core including lithium iron phosphate and a bismuth salt;
coating the core with a coating material to obtain a cathode material, the cathode material including a core and a conductive polymer coating layer arranged on at least a surface of the core;
coating a cathode current collector with the cathode material, to obtain a cathode plate by rolling;
coating a anode current collector with a anode material, to obtain a anode plate by rolling;
winding the cathode plate, the anode plate, and a separator to obtain a wound cell;
assembling the wound cell to obtain a battery module; and
injecting electrolyte into the battery module to obtain the secondary battery.

In a second aspect, some embodiments of the present disclosure provide a secondary battery, wherein the secondary battery is prepared with the method as described in the first aspect, and the secondary battery includes a cathode plate, a anode plate, a separator, and electrolyte, the cathode plate including a cathode current collector and a cathode material arranged on at least one surface of the cathode current collector;
the cathode material including a core and a coating layer distributed on at least part of a surface of the core, the core including lithium iron phosphate and a bismuth salt, at least part of the lithium iron phosphate and the bismuth salt being connected by chemical bonds, and a material of the coating layer including a conductive polymer.

Compared with the prior art, the technical solution achieves at least the following technical effects.

In the present disclosure, an intermediate solution including a lithium source, an iron source, a phosphorus source, a transition metal salt source, a bismuth source, and a solvent is subjected to a hydrothermal reaction and heat treatment to prepare a core including lithium iron phosphate and a bismuth salt. The lithium iron phosphate has an olivine crystal structure, which has a unique lithium ion diffusion path and stability. The bismuth salt has characteristics of high density and superconductivity. Moreover, during the hydrothermal reaction with a pH of 1.0 to 4.0, part of the transition metal salt source, the lithium source, the iron source, the phosphorus source, and the solvent can react with each other to form chemical bonds, thereby enabling at least part of the generated lithium iron phosphate to be connected to the bismuth salt by the chemical bonds. In the present disclosure, the lithium iron phosphate and the bismuth salt are jointly taken as the core, and the lithium iron phosphate and the bismuth salt are closely bonded, which can increase packing density between particles of the core and increase tap density of the core, thereby increasing energy density of the cathode material; and can also improve structural stability of the core, reduce structural damage caused by a volume change during charging and discharging, and improve cycle performance of the cathode material. Moreover, the bismuth salt has excellent structural stability at higher and lower temperatures, and can effectively improve high-and-low temperature performance of the cathode material. The core is then coated with a coating material so that a conductive polymer coating layer is distributed on a surface of the core, which can further enhance conductivity of the cathode material and improve rate performance of the cathode material. At the same time, the conductive polymer coating layer can inhibit volume expansion of the core under charge and discharge conditions, reduce volume expansion of the cathode material, and improve cycle performance of the secondary battery.

### BRIEF DESCRIPTION OF DRAWINGS

The present disclosure is further described below with reference to the accompanying drawings and embodiments.

FIG. 1 is a flowchart of preparation of a cathode material according to the present disclosure; and

FIG. 2 is a schematic structural diagram of the cathode material according to the present disclosure.

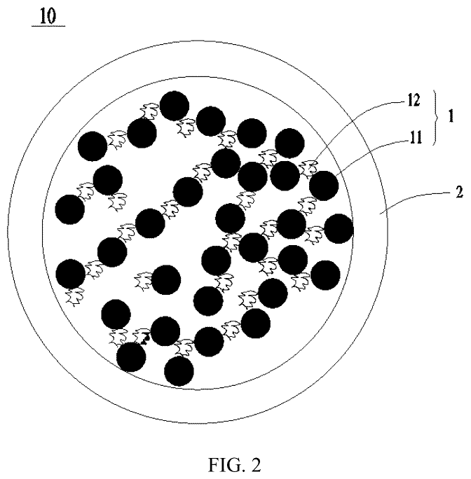

In FIG. 2,
10: cathode material;
1: core;
11: lithium iron phosphate;
12: bismuth salt;
2: coating layer.

### DESCRIPTION OF EMBODIMENTS

In order to better understand the technical solution of the present disclosure, embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the scope of protection of the present disclosure.

The terms used in the embodiments of the present disclosure are for the purpose of describing specific embodiments only, and are not intended to limit the present disclosure. As used in the embodiments of the present disclosure and the appended claims, the singular forms of “a/an”, “one”, and “the” are intended to include plural forms, unless otherwise clearly specified in the context.

It should be understood that the term “and/or” used herein describes an association relationship between associated objects and represents that three relationships may exist. For example, A and/or B may represent the following three cases: only A exists, both A and B exist, and only B exists. In addition, the character “/” generally indicates an “or” relationship between the associated objects.

Lithium iron phosphate, as a cathode material of a secondary battery, has advantages of high-rate charging, a long cycle life, and high stability. Compared with other cathode materials, the lithium iron phosphate has poor high-and-low temperature performance, poor kinetic properties, and weak conductivity, which limits power characteristics of lithium-ion batteries supported by the lithium iron phosphate. With respect to the above problems, researchers generally improve performance of the cathode material through technologies such as nanotechnology, carbon coating, and element doping. At the same time, by optimizing an electrolyte formula, using a new electrolyte salt, and introducing a low-viscosity co-solvent, low-temperature conductivity of the electrolyte can be increased and low-temperature performance of the battery can be improved. In existing methods, electrochemical performance of the lithium iron phosphate applied to the secondary battery is improved by optimizing the structure of the lithium iron phosphate or optimizing the electrolyte in the secondary battery.

In view of above situation, the present disclosure provides a secondary battery and a preparation method thereof, which uses a complex of a bismuth salt and lithium iron phosphate as a core, and a conductive polymer coating layer is provided on a surface of the core, thereby providing a new solution to improve first efficiency, a capacity, rate performance, cycle performance, and high-and-low temperature performance of the secondary battery.

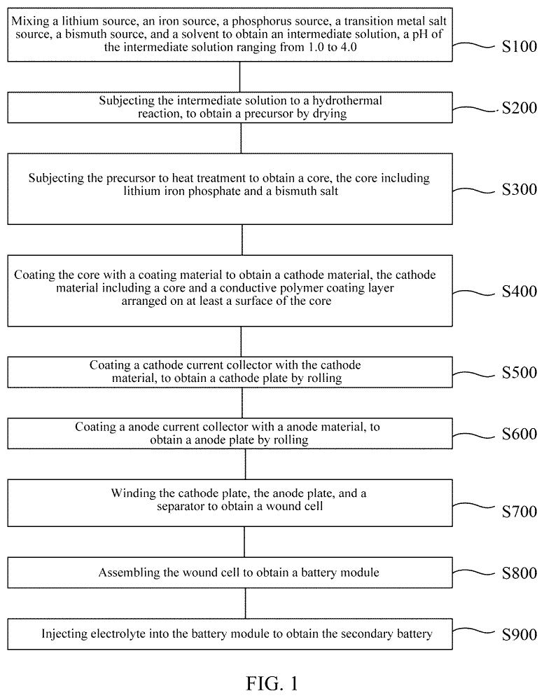

Some embodiments of the present disclosure provide a preparation method for a secondary battery. As shown in FIG. 1, FIG. 1 is a flowchart of preparation of a secondary battery according to the present disclosure, including the following steps:
mixing a lithium source, an iron source, a phosphorus source, a transition metal salt source, a bismuth source, and a solvent to obtain an intermediate solution, a pH of the intermediate solution ranging from 1.0 to 4.0;
subjecting the intermediate solution to a hydrothermal reaction, to obtain a precursor by drying;
subjecting the precursor to heat treatment to obtain a core, the core including lithium iron phosphate and a bismuth salt;
coating the core with a coating material to obtain a cathode material, the cathode material including a core and a conductive polymer coating layer arranged on at least a surface of the core;
coating a cathode current collector with the cathode material, to obtain a cathode plate by rolling;
coating an anode current collector with a anode material, to obtain a anode plate by rolling;
winding the cathode plate, the anode plate, and a separator to obtain a wound cell;
assembling the wound cell to obtain a battery module; and
injecting electrolyte into the battery module to obtain the secondary battery.

In the above solution, in the present disclosure, an intermediate solution including a lithium source, an iron source, a phosphorus source, a transition metal salt source, a bismuth source, and a solvent is subjected to a hydrothermal reaction and heat treatment to prepare a core including lithium iron phosphate and a bismuth salt. The lithium iron phosphate has an olivine crystal structure, which has a unique lithium ion diffusion path and stability. The bismuth salt has characteristics of high density and superconductivity. Moreover, during the hydrothermal reaction with a pH of 1.0 to 4.0, part of the transition metal salt source, the lithium source, the iron source, the phosphorus source, and the solvent can react with each other to form chemical bonds, thereby enabling at least part of the generated lithium iron phosphate to be connected to the bismuth salt by the chemical bonds. In the present disclosure, the lithium iron phosphate and the bismuth salt are jointly take as the core, and the lithium iron phosphate and the bismuth salt are closely bonded, which can increase packing density between particles of the core and increase tap density of the core, thereby increasing energy density of the cathode material; and can also improve structural stability of the core, reduce structural damage caused by a volume change during charging and discharging, and improve cycle performance of the cathode material. Moreover, the bismuth salt has excellent structural stability at higher and lower temperatures, and can effectively improve high-and-low temperature performance of the cathode material. The core is then coated with a coating material so that a conductive polymer coating layer is distributed on a surface of the core, which can further enhance conductivity of the cathode material and improve rate performance of the cathode material. At the same time, the conductive polymer coating layer can inhibit volume expansion of the core under charge and discharge conditions, reduce volume expansion of the cathode material, and improve cycle performance of the secondary battery.

In the related art, generally, bismuth tungstate (Bismuth tungstate) is used as the coating layer of the cathode material to improve conductivity of the material, and is used as a physical barrier of the core to improve rate performance and cycle performance of the cathode material. Different from the above related art, in the present disclosure, a core including a complex of lithium iron phosphate and a bismuth salt can be prepared in a one-step process, and the lithium iron phosphate and the bismuth salt are tightly coated inside the conductive polymer coating layer, which improves compaction density and structural stability of the cathode material and also improves conductivity. That is, the present disclosure provides a new idea for simultaneously improving energy density, rate performance, and cycle performance of a lithium iron phosphate cathode material.

The preparation method of the present disclosure is introduced below.

In S100, a lithium source, an iron source, a phosphorus source, a transition metal salt source, a bismuth source, and a solvent are mixed to obtain an intermediate solution, a pH of the intermediate solution ranging from 1.0 to 4.0.

In some embodiments, a molar ratio of the phosphorus source, the lithium source, the iron source, to the bismuth source is (1.0 to 1.15):(1.0 to 1.15): 1:(0.01 to 0.03), which may be, for example, 1.0:1.0:1:0.02, 1.05:1.0:1:0.01, 1.0:1.05:1:0.3, 1.1:1.15:1:0.03, 1.15:1.1:1:0.02, or the like. In the above defined range, it is conducive to subsequent generation of an appropriate amount of lithium iron phosphate and a bismuth salt, so that the lithium iron phosphate and the bismuth salt are jointly taken as the core to improve compaction density, structural stability, and high-and-low temperature resistance of the material and comprehensively improve electrochemical performance of the cathode material. If an addition amount of the bismuth source is excessively small, it is not enough to improve tap density and high-and-low temperature resistance of a lithium iron phosphate core. If the addition amount of the bismuth source is excessively large, a mass proportion of the lithium iron phosphate in the core is excessively small, affecting a capacity of the anode material.

In S101, the lithium source, the phosphorus source, the iron source, and the solvent are mixed to obtain a mixed solution including the lithium source and the iron source.

In this step, the lithium source, the iron source, and the phosphorus source are dissolved in the solvent in advance to obtain the mixed solution, so that the lithium source and the iron source can be fully dispersed, and the phosphorus source and the lithium source form lithium phosphate.

In some embodiments, the lithium source includes at least one of lithium carbonate, lithium phosphate, lithium hydroxide, and lithium chloride.

In some embodiments, the iron source includes a soluble iron salt. In some embodiments, the iron source includes at least one of ferrous sulfate, ferric nitrate, ferric chloride, ferric sulfate, and ferric oxalate.

In some embodiments, the phosphorus source includes at least one of iron phosphate, ammonium monohydrogen phosphate, ammonium dihydrogen phosphate, ammonium phosphate, and ferrous monohydrogen phosphate.

In some embodiments, iron phosphate may alternatively be directly used as the phosphorus source and the lithium source. That is, the lithium phosphate and the iron source are directly dissolved in the solvent to obtain a mixed solution.

In some embodiments, the solvent includes at least one of water, ethylene glycol, and anhydrous ethanol.

In some embodiments, an addition amount of the solvent ranges from 120 mL to 200 mL, which may be, for example, 120 mL, 130 mL, 140 mL, 150 mL, 160 mL, 170 mL, 180 mL, 190 mL, 200 mL, or the like.

In S102, the transition metal salt source and the bismuth source are added to the mixed solution in S101, and an acid solution is added, to obtain the intermediate solution, the pH of the intermediate solution ranging from 1.0 to 4.0.

In some embodiments, the transition metal salt source includes at least one of a tungsten source, a molybdenum source, and a vanadium source.

The tungsten source includes at least one of sodium tungstate, ammonium tungstate, and calcium tungstate.

The molybdenum source includes at least one of sodium molybdate and ammonium molybdate.

The vanadium source includes at least one of ammonium metavanadate and vanadic acid.

In some embodiments, the transition metal salt source is added to the mixed solution in a dropwise manner, so that the transition metal salt source can be evenly dispersed in the mixed solution, which helps control morphology of a bismuth salt generated by the transition metal salt source and the bismuth source. At the same time, the transition metal salt source may generate heat when dissolving. The dropwise addition manner helps to control a temperature of the mixed solution and prevent an influence on quality of the mixed solution due to local overheating.

In some embodiments, a molar ratio of the transition metal salt source to the bismuth source is (2.0 to 2.15):1, which may be, for example, 1.0:1, 2.05:1, 2.1:1, 2.15:1, or the like.

In some embodiments, the acid solution includes at least one of dilute nitric acid, hydrochloric acid, citric acid, and dilute sulfuric acid. The pH of the intermediate solution is adjusted to 1.0 to 4.0 by using the above acid solution, which, on the one hand, promotes formation of a stable crystalline bismuth salt, and on the other hand, in the subsequent hydrothermal reaction, enables part of the transition metal salt source, the lithium source, the iron source, the phosphorus source, and the solvent to react with each other to form chemical bonds, thereby ensuring structural stability of the core of the cathode material.

In some embodiments, the pH of the intermediate solution obtained after addition of the acid solution ranges from 1.0 to 4.0, which may be, for example, 1.0, 2.0, 3.0, 3.5, 4.0, or the like. In the above defined range, it is conducive to controlling morphology of the subsequently generated bismuth salt, so that the morphology of the bismuth salt may be at least one of a flower shape, a line shape, a nest shape, and a plate shape. The structure of the bismuth salt with the above morphology has more wrinkles, so that the bismuth salt has more microstructures and irregularities on the surface and an increased specific surface area, which, as part of the core, can provide more active sites, thereby improving electrochemical reaction efficiency of the cathode material.

In S200, the intermediate solution is subjected to a hydrothermal reaction, to obtain a precursor by drying.

In this step, the intermediate solution is subjected to the hydrothermal reaction, and the transition metal salt source and the bismuth source react to form a bismuth salt with specific morphology and size. At the same time, during the hydrothermal reaction, the lithium source, the iron source, and the phosphorus source may also generate a lithium iron phosphate precursor, and a temperature of the hydrothermal reaction may also affect a size of the lithium iron phosphate precursor. Moreover, in a strongly acidic hydrothermal reaction environment, part of the transition metal salt source, the lithium source, the iron source, the phosphorus source, and the solvent can react with each other to form chemical bonds, thereby enabling at least part of the generated lithium iron phosphate to be connected to the bismuth salt by the chemical bonds, which helps improve compaction density and structural stability of the material. In some embodiments, the above chemical bonds are polar covalent bonds.

In some embodiments, a temperature of the hydrothermal reaction ranges from 140° C. to 200° C., which may be, for example, 140° C., 150° C., 160° C., 170° C., 180° C., 190° C., 200° C., or the like. In the above defined range, it is conducive to obtaining a bismuth salt with a good crystallization degree and a moderate grain size, and at the same time, conducive to formation of chemical bonds in a strongly acidic hydrothermal system. If the temperature of the hydrothermal reaction is higher than 200° C., it leads to excessive growth of grains during the hydrothermal reaction, resulting in an excessively large grain size, which is not conducive to increasing the tap density of the cathode material. Moreover, an excessively high hydrothermal temperature may cause agglomeration and affect the structural stability of the cathode material. If the temperature of the hydrothermal reaction is lower than 140° C., it is not conducive to growth of bismuth salt crystals, and crystallinity of the generated bismuth salt crystals is low, resulting in presence of impurities in a product, which cannot effectively improve the structural stability and high-and-low temperature resistance of the cathode material.

In some embodiments, a duration time of the hydrothermal reaction ranges from 12 h to 20 h, which may be, for example, 12 h, 13 h, 14 h, 15 h, 16 h, 17 h, 18 h, 19 h, 20 h, or the like. In the above defined range, it is conducive to obtaining a bismuth salt with a good crystallization degree and a moderate grain size. If the a duration time of the hydrothermal reaction is longer than 20 h, it leads to excessive growth of grains during the hydrothermal reaction, resulting in an excessively large grain size, which is not conducive to increasing the tap density of the cathode material. Moreover, an excessively high hydrothermal temperature may cause agglomeration and affect the structural stability of the cathode material. If the a duration time of the hydrothermal reaction is shorter than 12 h, it is not conducive to growth of bismuth salt crystals, and crystallinity of the generated bismuth salt crystals is low, resulting in presence of impurities in a product, which cannot effectively improve the structural stability and high-and-low temperature resistance of the cathode material.

In the present disclosure, by controlling the temperature and the a duration time of the hydrothermal reaction, sizes of the subsequently generated lithium iron phosphate and bismuth salt are controlled, so that an average diameter of the bismuth salt is controlled within a range of 1 μm to 2 μm and an average diameter of the lithium iron phosphate within a range of 3 μm to 5 μm, to obtain a composite core of two different particle sizes, so size matching between the lithium iron phosphate and the bismuth salt can improve the tap density of the cathode material and improve a capacity, rate performance, and cycle performance of the cathode material. In addition, in the present disclosure, morphology of the bismuth salt generated is controlled according to the temperature and a duration time of the hydrothermal reaction. In the defined range in the present disclosure, it is conducive to formation of a bismuth salt with more wrinkles and a larger specific surface area, thereby increasing reactive sites in the core.

In this step, when the transition metal salt source is selected from the tungsten source, the intermediate solution including tungsten generates bismuth tungstate (Bi₂WO₆) during the hydrothermal reaction. Bismuth tungstate has an orthorhombic crystal structure, whose crystal structure is formed by alternately stacking Bi₂O₂²⁺ layers and WO₄²⁻ layers, such as a Bismuth tungstate spinel crystal structure which has excellent structural stability and thermal stability and can maintain its structural stability over a wider temperature range.

When the transition metal salt source is selected from the molybdenum source, the intermediate solution including molybdenum generates bismuth molybdate (Bi₂MoO₆) during the hydrothermal reaction. Bismuth molybdate has an orthorhombic crystal structure. In Bismuth molybdate crystals, molybdenum and oxygen atoms form a series of octahedral structures, bismuth atoms are located between the above octahedrons, the molybdenum and oxygen atoms have strong ionic interaction, and the bismuth atoms are located in gaps and are not connected by chemical bonds, so that Bismuth molybdate has higher structural stability.

When the transition metal salt source is selected from the vanadium source, the intermediate solution including vanadium generates bismuth vanadate (BiO₄V) during the hydrothermal reaction. Bismuth vanadate has a monoclinic scheelite structure, which is a tetrahedral coordination crystal structure. Bismuth vanadate crystals are arranged by vanadate ions (VO₃⁻) and bismuth ions (Bi₃⁺) in a certain manner and are connected to each other by strong chemical bonds. Such arrangement and connection make the Bismuth vanadate crystals have good structural stability and heat resistance.

The bismuth salt has good structural stability and heat resistance and is compounded with the lithium iron phosphate as the core, so that the cathode material can keep a crystal structure unchanged during the charging and discharging, which helps resist expansion and contraction of the cathode material during the charging and discharging, reduce breakage of particles, resist erosion of the electrolyte, and reduce interface side reactions, thereby prolonging the cycle life of the cathode material. Moreover, in a high-temperature environment, crystals of the bismuth salt with a stable structure and the lithium iron phosphate core can resist thermal decomposition, reduce a risk of thermal runaway, and improve safety of the secondary battery.

In some embodiments, drying includes at least one of spray drying and evaporation drying. For example, spray drying is centrifugal spray drying using a spray dryer.

In some embodiments, a temperature of drying ranges from 50° C. to 500° C., which may be, for example, 50° C., 100° C., 150° C., 200° C., 250° C., 300° C., 350° C., 400° C., 450° C., 500° C., or the like.

In some embodiments, a duration time of drying ranges from 0.1 h to 10 h, which may be, for example, 0.1 h, 0.5 h, 1 h, 3 h, 5 h, 8 h, 10 h, or the like.

In some embodiments, after drying, a grinding operation is further included, through which the particle size is reduced, the specific surface area is increased, and a diffusion rate of active substances and lithium ions is increased. Moreover, grinding can destroy an agglomeration structure between particles, reduce formation of large particle size agglomerates, and improve material utilization. In some embodiments, grinding may be ball milling or sand grinding. For example, the ball milling operation is carried out in an SX-8 ball mill.

In S300, the precursor is subjected to heat treatment to obtain a core, the core including lithium iron phosphate and a bismuth salt.

In some embodiments, a temperature of the heat treatment ranges from 400° C. to 800° C., which may be, for example, 400° C., 450° C., 480° C., 500° C., 550° C., 600° C., 650° C., 700° C., 750° C., 800° C., or the like. In the above defined range, the lithium iron phosphate prepared in the present disclosure has high powder compaction performance and helps to obtain high energy density. If the temperature of the heat treatment is lower than 400° C., grain growth of the material may be incomplete, and crystallinity and powder compaction performance of the obtained lithium iron phosphate may be poor. If the temperature of the heat treatment is higher than 800° C., it leads to excessive growth of lithium iron phosphate grains, resulting in a reduction in the specific surface area of the cathode material and a reduction in the diffusion rate of lithium ions, thereby affecting the rate performance.

In some embodiments, a duration time of the heat treatment ranges from 3 h to 8 h, which may be, for example, 3 h, 4 h, 5 h, 6 h, 7 h, 8 h, or the like.

In S400, the core is coated with a coating material to obtain a cathode material, the cathode material including a core and a conductive polymer coating layer arranged on at least a surface of the core.

In this step, by coating the core, a conductive polymer coating layer is formed on the surface of the core. The conductive polymer can increase conductivity of the cathode material. At the same time, the conductive polymer coats the core, which reduces volume expansion of the positive electrode during the charging and discharging and helps improve the cycle performance of the cathode material.

In some embodiments, the coating the core with a coating material includes: mixing a polymer monomer, an oxidant, and the core. The polymer monomer undergoes a chemical oxidative polymerization reaction under the action of the oxidant to prepare a conductive polymer.

In some embodiments, the polymer monomer includes at least one of aniline, pyrrole, amide, acrylic acid, and ethylene oxide. The above polymer monomer can generate a conductive polymer with good conductivity, which increases the conductivity of the cathode material, thereby improving the rate performance thereof.

In some embodiments, the oxidant includes at least one of persulfate, hydrogen peroxide, and potassium dichromate. In some embodiments, sulfate may be, for example, ammonium persulfate, sodium persulfate, or the like.

In some embodiments, a molar ratio of the polymer monomer to the core is (2 to 8):1, which may be, for example, 2:1, 3:1, 4:1, 5:1, 6:1, 7:1, 8:1, or the like. In the above defined range, the conductive polymer coating layer generated from the polymer monomer can completely cover the core and have an appropriate thickness to prevent degradation of electrochemical performance caused by an excessively thick or excessively thin coating layer.

In some embodiments, a molar ratio of the polymer monomer to the oxidant is 1:(0.2 to 0.8), which may be, for example, 1:0.2, 1:0.3, 1:0.4, 1:0.5, 1:0.6, 1:0.7, 1:0.8, or the like.

In some embodiments, a temperature of the mixing operation ranges from 0° C. to 5° C., which may be, for example, 0° C., 1° C., 2° C., 3° C., 4° C., 5° C., or the like. In the above defined range, on the one hand, in the present disclosure, the temperature of the mixing is lower, which prevents volatilization of the polymer monomer and helps slow down a polymerization reaction rate, thereby obtaining a conductive polymer that evenly coats the core. On the other hand, a lower mixing temperature can reduce decomposition of oxides, reduce side reactions during chemical polymerization, and ensure controllability and safety of the reaction during the mixing. If the temperature of the mixing is higher than 5° C., some unnecessary side reactions may occur during the mixing, affecting the structure and performance of the generated conductive polymer.

In some embodiments, a duration time of the mixing ranges from 4 h to 8 h, which may be, for example, 4 h, 5 h, 6 h, 7 h, or 8 h.

In S500, a cathode current collector is coated with the cathode material, to obtain a cathode plate by rolling.

In some embodiments, the cathode current collector includes a copper foil, an aluminum foil, a nickel foil, a composite current collector, and the like.

In some embodiments, prior to the coating a cathode current collector with the cathode material, the method further includes: mixing the cathode material prepared above, a conductive agent, and a binder to obtain slurry, and then coating the cathode current collector with the slurry.

In some embodiments, the conductive agent may include at least one of conductive carbon black, flake graphite, graphene, and a carbon nanotube.

In some embodiments, the binder may include at least one of polyvinylidene fluoride, a copolymer of vinylidene fluoride-hexafluoropropylene, a styrene-acrylate copolymer, a styrene-butadiene copolymer, polyamide, polyacrylonitrile, polyacrylic ester, polyacrylic acid, polyacrylate, sodium carboxymethyl cellulose, polyvinyl acetate, polyvinylpyrrolidone, polyvinyl ether, polymethyl methacrylate, polytetrafluoroethylene, and polyhexafluoropropylene.

In some embodiments, two sides of the cathode current collector may be coated with the slurry by at least one of blade coating, roll transfer coating, and slit die coating. During the coating, a coating speed, pressure, and a gap of a coating head are required to be controlled to obtain a uniform coating layer. In some embodiments, the coating speed is greater than or equal to 80 m/min, which may be, for example, 80 m/min, 85 m/min, 90 m/min, 100 m/min, 110 m/min, 120 m/min, or the like.

In some embodiments, after the coating, the method further includes: drying a wet film obtained by coating to remove moisture and other volatile components. In some embodiments, a drying device may be, for example, an oven.

In some embodiments, a coating product is rolled to obtain a cathode plate. A rolling device may be, for example, a roller press. The coating product may be compacted by using pressure of a roller in the roller press. During the rolling, a thickness of the electrode plate may decrease and density may increase, improving density and electrochemical performance of the cathode plate. In some embodiments, a rolling speed is less than or equal to 90 m/min, which may be, for example, 30 m/min, 40 m/min, 50 m/min, 60 m/min, 70 m/min, 80 m/min, 90 m/min, or the like. Accuracy of the thickness of the plate obtained after rolling is +3 μm.

In S600, an anode current collector is coated with a anode material, to obtain a anode plate by rolling.

In some embodiments, the anode material includes a negative electrode active material, a conductive agent, and a binder.

In some embodiments, the negative electrode active material includes at least one of soft carbon, hard carbon, artificial graphite, natural graphite, amorphous carbon, a silicon oxide compound, and lithium titanate.

In some embodiments, the binder may include at least one of carboxymethyl cellulose (CMC), polyacrylic acid, polyvinylpyrrolidone, polyaniline, polyimide, polyamideimide, polysiloxane, polystyrene-butadiene rubber, epoxy resin, polyester resin, polyurethane resin, and polyfluorene.

In some embodiments, the conductive agent may include at least one of conductive carbon black, Ketjen black, acetylene black, a carbon nanotube, and graphene.

In some embodiments, two sides of the anode current collector may be coated with the anode material by at least one of blade coating, roll transfer coating, and slit die coating. During the coating, a coating speed, pressure, and a gap of a coating head are required to be controlled to obtain a uniform coating layer. In some embodiments, the coating speed is greater than or equal to 80 m/min, which may be, for example, 80 m/min, 85 m/min, 90 m/min, 100 m/min, 110 m/min, 120 m/min, or the like.

In some embodiments, after the coating, the method further includes: drying a wet film obtained by coating to remove moisture and other volatile components. In some embodiments, a drying device may be, for example, an oven.

In some embodiments, a coating product is rolled to obtain an anode plate. A rolling device may be, for example, a roller press. The coating product may be compacted by using pressure of a roller in the roller press. During the rolling, a thickness of the electrode plate may decrease and density may increase, improving density and electrochemical performance of the anode plate. In some embodiments, a rolling speed is less than or equal to 90 m/min, which may be, for example, 30 m/min, 40 m/min, 50 m/min, 60 m/min, 70 m/min, 80 m/min, 90 m/min, or the like. Accuracy of the thickness of the plate obtained after rolling is +3 μm.

In S700, the cathode plate, the anode plate, and a separator are wound to obtain a wound cell.

In some embodiments, prior to winding, the cathode plate and the anode plate are cut separately, the cathode plate and the anode plate are divided into fixed widths to form a tab state required by a battery structure.

In this step, the cathode plate, an upper separator, the anode plate, and a lower separator are stacked in order, are wound by a rolling needle to form an independent bare cell, and are fixed by finishing glue.

In some embodiments, the upper separator includes at least one of polyethylene, polypropylene, polyvinylidene fluoride, polyethylene terephthalate (PET), polyimide, and aramid. The lower separator includes at least one of polyethylene, polypropylene, polyvinylidene fluoride, PET, polyimide, and aramid. In some embodiments, a thickness of the upper separator and/or the lower separator is within a range of approximately 5 μm to 500 μm.

In S800, the wound cell is assembled to obtain a battery module.

The assembling the wound cell includes: subjecting the bare cell to high temperature and high pressure shaping, and testing, by a high potential test (Hi-Pot), whether there is a risk of short circuit inside the bare cell, which may be tested by, for example, detecting a separator defect or burrs inside the bare cell. Further, access detection is performed on the bare cell to determine a pairing relationship, and the bare cell is fixed by applying winding adhesive. Further, a tab and a connecting sheet of the bare cell are welded by using an ultrasonic welding technology. Further, an outer surface of the bare cell is coated with a PET sheet, and the two are fixed by hot melting. Finally, the coated bare cell is pushed into an aluminum shell and welded by laser to ensure sealing performance of the cell.

In S900, electrolyte is injected into the battery module to obtain the secondary battery.

In this step, firstly, the inside of the battery module is vacuumed, then, the electrolyte is injected into the battery module, and the electrolyte is quickly absorbed by the cell through repeated vacuum or positive pressure, and finally standing treatment is carried out, so that all materials in the battery module are fully infiltrated by the electrolyte.

In some embodiments, the electrolyte includes, but is not limited to, at least two of dimethyl carbonate (DMC), ethyl methyl carbonate (EMC), diethyl carbonate (DEC), ethylene carbonate (EC), propylene carbonate (PC), and propyl propionate (PP). In addition, the electrolyte may additionally include at least one of vinylene carbonate (VC), fluoroethylene carbonate (FEC), and a dinitrile compound as an electrolyte additive.

In some embodiments, subsequent to the injecting electrolyte, the method further includes forming and packaging the battery module to make the secondary battery. It may be understood that the secondary battery made in the present disclosure is a lithium-ion battery. Finally, the secondary battery prepared is subjected to performance testing.

Some embodiments of the present disclosure further provide a secondary battery prepared with the preparation method above. The secondary battery includes a cathode plate, an anode plate, a separator, and electrolyte. The cathode plate includes a cathode current collector and a cathode material arranged on at least one surface of the cathode current collector.

FIG. 2 is a schematic structural diagram of a cathode material according to some embodiments of the present disclosure. Referring to FIG. 2, the cathode material 10 includes a core 1 and a coating layer 2 distributed on at least part of a surface of the core 1, the core 1 includes lithium iron phosphate 11 and a bismuth salt 12, and at least part of the lithium iron phosphate 11 and the bismuth salt 12 are connected by chemical bonds. A material of the coating layer 2 includes a conductive polymer.

In the above solution, in the present disclosure, the cathode material 10 has a core-shell structure, the core 1 includes a compound of the lithium iron phosphate 11 and the bismuth salt 12, at least part of the lithium iron phosphate 11 and the bismuth salt 12 are connected by chemical bonds, the lithium iron phosphate 11 has an olivine crystal structure, which has a unique lithium ion diffusion path and stability, and the bismuth salt 12 has characteristics of high density and superconductivity. In the present disclosure, the lithium iron phosphate 11 and the bismuth salt 12 are jointly take as the core 1, and the lithium iron phosphate 11 and the bismuth salt 12 are closely bonded, which can increase packing density between particles of the core 1 and increase tap density of the core 1, thereby increasing energy density of the cathode material; and can also improve structural stability of the core 1, reduce structural damage caused by a volume change during charging and discharging, and improve cycle performance of the cathode material. Moreover, the bismuth salt 12 has excellent structural stability at higher and lower temperatures, and can effectively improve high-and-low temperature performance of the cathode material. A housing 2 is a conductive polymer coating layer. The presence of the conductive polymer coating layer can further enhance conductivity of the cathode material 10 and improve rate performance of the cathode material 10. At the same time, the conductive polymer coating layer can inhibit volume expansion of the core 1 under charge and discharge conditions, reduce volume expansion of the cathode material 10, and improve cycle performance of the secondary battery.

In some embodiments, an average diameter of the lithium iron phosphate 11 is greater than that of the bismuth salt 12. In the present disclosure, by using large-grained lithium iron phosphate 11 and small-grained bismuth salt 12 jointly as the core, it is conducive to increasing tap density of the cathode material, thereby increasing energy density of the cathode material. Moreover, compared with the lithium iron phosphate 11, a lithium ion diffusion distance of the bismuth salt 12 with a smaller particle size is shorter, which improves lithium ion transport efficiency of the bismuth salt 12 and improves conductivity, thereby improving rate performance of the cathode material 10. In addition, the bismuth salt 12 with a smaller particle size can also increase a solid-liquid transport interface between the cathode material 10 and the electrolyte, and improve dynamics performance and low-temperature performance of the cathode material 10.

In some embodiments, the average diameter of the lithium iron phosphate 11 ranges from 3 μm to 5 μm, which may be, for example, 3 μm, 3.2 μm, 3.5 μm, 3.8 μm, 4 μm, 4.5 μm, 4.7 μm, 5 μm, or the like. In the above range, it indicates that the particle size of the lithium iron phosphate 11 is moderate, which can reduce side reactions of the cathode material 10 and improve transport performance of lithium ions, thereby improving comprehensive electrochemical performance of the cathode material 10.

In some embodiments, the average diameter of the bismuth salt 12 ranges from 1 μm to 2 μm, which may be, for example, 1 μm, 1.2 μm, 1.4 μm, 1.5 μm, 1.7 μm, 1.8 μm, 2 μm, or the like. In the above range, it indicates that the particle size of the bismuth salt 12 is smaller, which is conducive to deintercalation and intercalation of the lithium ions during charging and discharging of the cathode material 10, improving rate performance of the cathode material 10. If the average diameter of the bismuth salt 12 is less than 1 μm, particles of the bismuth salt 12 are seriously agglomerated, which is not conducive to improving cycle performance of the cathode material 10, reduces dispersion performance of the cathode material 10 as slurry, and is not conducive to improving processing performance of the cathode material 10 applied to the secondary battery. If the average diameter of the bismuth salt 12 is greater than 2 μm, a diffusion length of the lithium ions may be increased, which is not conducive to improving the dynamics performance of the cathode material 10.

In the present disclosure, both the lithium iron phosphate and the bismuth salt take an average diameter of at least one hundred particles as the average diameter thereof.

In some embodiments, the bismuth salt 12 includes at least one of Bismuth tungstate, Bismuth molybdate, and Bismuth vanadate. The above three bismuth salts 12 all have good structural stability and heat resistance and are compounded with the lithium iron phosphate 11 as the core 1, so that the cathode material 10 can keep a crystal structure unchanged during the charging and discharging, which helps resist expansion and contraction of the cathode material 10 during the charging and discharging, reduce breakage of particles, resist erosion of the electrolyte, and reduce interface side reactions, thereby prolonging the cycle life of the cathode material 10. Moreover, in a high-temperature environment, crystals of the bismuth salt 12 with a stable structure can resist thermal decomposition, reduce a risk of thermal runaway, and improve safety of the secondary battery.

In some embodiments, the conductive polymer includes at least one of polyaniline, polypyrrole, polyamide, polyacrylic acid, and polyethylene oxide. The above conductive polymers all have excellent conductivity and can improve battery conductivity of the cathode material, thereby improving charge and discharge performance of the secondary battery. Moreover, the above conductive polymer has good structural stability, can provide additional structural support for the core, and reduce structural stress and damage during the charging and discharging of the secondary battery.

In some embodiments, morphology of the lithium iron phosphate 11 is spheroidal. In some embodiments, the morphology of the lithium iron phosphate 11 is spherical. The structure of the lithium iron phosphate 11 whose morphology is spheroidal has a high theoretical specific capacity and can increase the energy density of the cathode material 10. Moreover, the lithium iron phosphate 11 whose morphology is spheroidal helps reduce volume changes and thermal stability of the cathode material 10 during charging and discharging, and can prolong the cycle life and improve safety performance of the cathode material 10 applied to the secondary battery.

In some embodiments, morphology of the bismuth salt 12 is at least one of a flower shape, a line shape, a nest shape, and a plate shape. The structure of the bismuth salt 12 with the above morphology has more wrinkles, so that the bismuth salt 12 has more microstructures and irregularities on the surface and an increased specific surface area, which, as part of the core 1, can provide more active sites, thereby improving electrochemical reaction efficiency of the cathode material.

Since the bismuth salt in the present disclosure has a non-spheroidal shape, the average diameter of the bismuth salt is measured and calculated by: selecting any bismuth salt particle, measuring a maximum diameter and a minimum diameter of the particle, and taking an average value of the maximum diameter and the minimum diameter as a diameter of the particle.

In some embodiments, a molar ratio of the lithium iron phosphate to the bismuth salt is 100:(1 to 3), which may be, for example, 100:1, 100:1.5, 100:2, 100:2.5, 100:3, or the like. If the proportion of the bismuth salt is excessively high, a mass proportion of the lithium iron phosphate in the core is excessively small, leading to deterioration of a capacity of the cathode material. If the proportion of the bismuth salt is excessively small, the tap density of the cathode material may deteriorate, and high-and-low temperature performance and cycle performance of the cathode material may deteriorate.

In some embodiments, tap density of the cathode material ranges from 2.5 g/cm³ to 2.6 g/cm³, which may be, for example, 2.5 g/cm³, 2.52 g/cm³, 2.54 g/cm³, 2.55 g/cm³, 2.58 g/cm³, or 2.6 g/cm³. In the above defined range, it indicates that the cathode material in the present disclosure has appropriate tap density and can effectively increase the capacity of the cathode material and charge and discharge efficiency under high-rate charge and discharge conditions.

In some embodiments, electrical resistivity of the cathode material ranges from 10 Ω·m to 20 Ω·m, which may be, for example, 10 Ω·m, 11 Ω·m, 12 Ω·m, 13 Ω·m, 14 Ω·m, 15 Ω·m, 16 Ω·m, 17 Ω·m, 18 Ω·m, 19 Ω·m, or 20 Ω·m. In the above defined range, it indicates that the cathode material in the present disclosure has lower electrical resistivity and higher conductivity, which helps improve transport efficiency and charge and discharge performance of the cathode material.

The following are typical but non-limiting examples of the present disclosure.

### Example 1

(1) 2.1 mol lithium phosphate and 2.0 mol ferrous sulfate were weighed respectively, and were dispersed in deionized water, to prepare a lithium salt solution and an iron salt solution.

(2) 0.04 mol Bi(NO3)₃·5H₂O and 0.02 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 130° C. for 12 h.

(4) The material obtained in step (3) was dried and ground to obtain solid powder, and the solid powder was heat-treated at 550° C. for 6 h to obtain a core.

(5) 0.12 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 2

(1) 2.0 mol lithium phosphate and 2.0 mol ferrous sulfate were weighed respectively, and were dispersed in deionized water, to prepare a lithium salt solution and an iron salt solution.

(2) 0.0205 mol Bi(NO3)₃·5H₂O and 0.01 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 120° C. for 12 h.

(4) The material obtained in step (3) was dried and ground to obtain solid powder, and the solid powder was heat-treated at 500° C. for 6 h to obtain a core.

(5) 0.02 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 3

(1) 2.2 mol lithium phosphate and 2.0 mol ferrous sulfate were weighed respectively, and were dispersed in deionized water, to prepare a lithium salt solution and an iron salt solution.

(2) 0.06 mol Bi(NO3)₃·5H₂O and 0.03 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 140° C. for 12 h.

(4) The material obtained in step (3) was dried and ground to obtain solid powder, and the solid powder was heat-treated at 600° C. for 6 h to obtain a core.

(5) 0.24 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 4

(1) 2.2 mol lithium phosphate and 2.0 mol ferrous sulfate were weighed respectively, and were dispersed in deionized water, to prepare a lithium salt solution and an iron salt solution.

(2) 0.06 mol Bi(NO3)₃·5H₂O and 0.03 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 150° C. for 12 h.

(4) The material obtained in step (3) was dried and ground to obtain solid powder, and the solid powder was heat-treated at 650° C. for 6 h to obtain a core.

(5) 0.12 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 5

(1) 2.2 mol lithium phosphate and 2.0 mol ferrous sulfate were weighed respectively, and were dispersed in deionized water, to prepare a lithium salt solution and an iron salt solution.

(2) 0.06 mol Bi(NO3)₃·5H₂O and 0.03 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 160° C. for 12 h.

(4) The material obtained in step (3) was dried and ground to obtain solid powder, and the solid powder was heat-treated at 700° C. for 6 h to obtain a core.

(5) 0.36 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 6

(1) 2.2 mol lithium phosphate and 2.0 mol ferrous sulfate were weighed respectively, and were dispersed in deionized water, to prepare a lithium salt solution and an iron salt solution.

(2) 0.06 mol Bi(NO3)₃·5H₂O and 0.03 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 170° C. for 12 h.

(4) The material obtained in step (3) was dried and ground to obtain solid powder, and the solid powder was heat-treated at 750° C. for 6 h to obtain a core.

(5) 0.42 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 7

(1) 2.2 mol lithium phosphate and 2.0 mol ferrous sulfate were weighed respectively, and were dispersed in deionized water, to prepare a lithium salt solution and an iron salt solution.

(2) 0.06 mol Bi(NO3)₃·5H₂O and 0.03 mol Na₂WO₄·2H₂O were added to the above solutions respectively to obtain a mixed solution, a pH of the mixed solution was adjusted to 2 with dilute nitric acid, and the mixed solution was continuously dispersed and stirred for 1 h.

(3) The material obtained in step (2) was placed in a high-pressure hydrothermal reactor and subject to a hydrothermal reaction at 170° C. for 12 h.

(4) The material obtained in step (3) was dried and ground to obtain solid powder, and the solid powder was heat-treated at 800° C. for 6 h to obtain a core.

(5) 0.48 mol aniline and 5 mmol ammonium persulfate were weighed respectively, and the core, the aniline, and the ammonium persulfate were mixed for a chemical polymerization reaction at a temperature of 2° C. for 5 h, to obtain a cathode material.

In this example, the cathode material included a core-shell structure, the core included lithium iron phosphate and Bismuth tungstate connected by polar covalent bonds, and the housing was a polyaniline coating layer.

### Example 8

Different from Example 1, Na₂WO₄·2H₂O in step (2) was replaced with “Na₂MoO₄·2H₂O”.

In this example, the cathode material included a core-shell structure, the core included lithium iron phosphate and Bismuth molybdate connected by polar covalent bonds, and the housing was a polyaniline coating layer.

### Example 9

Different from Example 1, step (2) was: adding 0.06 mol Bi(NO3)₃·5H₂O and 0.08 mol NH₄VO₃ to the above solutions respectively to obtain a mixed solution, adjusting a pH of the mixed solution to 2 with dilute nitric acid, and continuously dispersing and stirring the mixed solution for 1 h.

In this example, the cathode material included a core-shell structure, the core included lithium iron phosphate and Bismuth vanadate connected by polar covalent bonds, and the housing was a polyaniline coating layer.

### Comparative Example 1

(1) 2.10 mol lithium phosphate and 2.0 mol ferrous sulfate were weighed respectively, and the lithium phosphate and the ferrous sulfate were mixed and dried and then were calcined at 550° C. for 6 h to obtain lithium iron phosphate.

(2) 0.02 mol aniline and 5 mmol ammonium persulfate were weighed respectively, and the lithium iron phosphate, the aniline, and the ammonium persulfate were mixed for a chemical polymerization reaction at a temperature of 0° C. for 5 h, and were dried and washed to obtain a lithium iron phosphate/polyaniline composite material.

(3) 0.0205 mol Bi(NO3)₃·5H₂O and 0.01 mol Na₂WO₄·2H₂O were weighed respectively, Bi(NO3)₃·5H₂O and Na₂WO₄·2H₂O were added to 200 ml of deionized water respectively and were dispersed for 1 h, a pH of the solution was adjusted to 3 with dilute nitric acid, the lithium iron phosphate/polyaniline composite material obtained in step (2) was added to the above solution and continuously stirred for 1 h, and then transferred to a high-pressure reactor and heated at 140° C. for 12 h, and after being cooled to room temperature, the solution was alternately washed with deionized water and anhydrous ethanol, then dried at 80° C. for 12 h, and ground to obtain a cathode material.

In this comparative example, the cathode material included a core-shell structure, the core was lithium iron phosphate, and the housing was a polyaniline coating layer and a Bismuth tungstate coating layer. A surface of the lithium iron phosphate was coated with polyaniline, and a surface of the polyaniline was coated with Bismuth tungstate.

### Comparative Example 2

Different from Example 1, step (5) was not performed.

In this comparative example, the cathode material included lithium iron phosphate and Bismuth tungstate.

### Comparative Example 3

(1) 2.1 mol lithium phosphate and 2.0 mol ferrous sulfate were weighed respectively, dispersed in deionized water for 1 h, dried, and then calcined at 700° C. for 6 h to obtain a lithium iron phosphate core.

(2) 0.12 mol aniline and 5 mmol ammonium persulfate were weighed respectively, and the lithium iron phosphate core, the aniline, and the ammonium persulfate were mixed for a chemical polymerization reaction at a temperature of 2° C. for 5 h, to obtain a cathode material.

In this comparative example, the cathode material included a core-shell structure, the core was lithium iron phosphate, and the housing was a polyaniline coating layer.

### Comparative Example 4

(1) 2.1 mol lithium phosphate and 2.0 mol ferrous sulfate were weighed respectively, dispersed in deionized water for 1 h, dried, and then calcined at 700° C. for 6 h to obtain lithium iron phosphate.

(2) 0.04 mol Bi(NO3)₃·5H₂O and 0.02 mol Na₂WO₄·2H₂O were respectively added to 200 ml of deionized water to obtain a mixed solution, a pH of the mixed solution was adjusted to 3 with dilute nitric acid, and the obtained material was placed into a high-pressure hydrothermal reactor, subjected to a hydrothermal reaction at 160° C. for 12 h, dried, and ground to obtain Bismuth tungstate solid powder.

(3) The lithium iron phosphate obtained in step (1), Bismuth tungstate obtained in step (2), and commercially available polyaniline (purchased from McLean) were mixed and ground evenly to obtain a cathode material.

In this comparative example, the cathode material included a physical mixture of lithium iron phosphate, Bismuth tungstate, and polyaniline.

### Performance Test

The following performance tests were performed on the cathode materials obtained in the examples and the comparative examples.
(1) Tap density test: A tap density test was carried out on the cathode materials obtained in the examples and the comparative examples respectively in accordance with GB/T 24533-2009.
(2) Electrical resistivity test: The cathode materials obtained in the examples and the comparative examples were tested using a two probe method or a four probe method and electrical resistivity was calculated.
(3) Electrochemical Performance Test

The cathode material obtained in the examples and the comparative examples, conductive carbon black SP, and a binder PVDF were added to 5 g N-methylpyrrolidone (NMP) at a mass ratio of 8:1:1, ultrasonic dispersion was carried out for 10 min followed by magnetic stirring for 1 h, a cathode current collector (aluminum foil) was evenly coated with obtained slurry, which were then placed in a 65° C. vacuum drying oven to be dried for 12 h to obtain an electrode plate, and the electrode plate was cooled to room temperature and cut into a small wafer with a radius of 7 mm by a microtome, that is, a cathode plate.

Then, in a vacuum glove box, a negative electrode shell, an elastic piece, a gasket, a anode plate (graphite), a separator (polypropylene microporous film), electrolyte (1 mol/L LiPF₆), a cathode plate, and a positive electrode shell were assembled, and after the assembly was completed, the electrolyte was fully infiltrated for 6 h to prepare a button-type full battery.

An electrical performance test was carried out on the button-type full battery. During the test, charging and discharging were carried out at a constant current of 0.1C, a test environment was 25±2° C., and a charge and discharge voltage range was 3.5 V to 3.7 V. Test results are shown in Table 1.

TABLE 1
Parameters of cathode materials prepared
in examples and comparative examples

| | | | | | 300-cycle |
|---|---|---|---|---|---|
| | Tap | Electrical | 0.1 C gram | First | capacity |
| | density | resistivity | capacity | efficiency | retention |
| | (g/cm³) | (Ω · m) | (mAh/g) | (%) | rate (%) |
| Example 1 | 2.53 | 12 | 187 | 98.5 | 99.4 |
| Example 2 | 2.52 | 15 | 185 | 98.3 | 99.3 |
| Example 3 | 2.55 | 11 | 188 | 98.7 | 99.2 |
| Example 4 | 2.54 | 12 | 189 | 98.6 | 99.2 |
| Example 5 | 2.52 | 16 | 187 | 98.7 | 99.3 |
| Example 6 | 2.54 | 17 | 188 | 98.6 | 99.1 |
| Example 7 | 2.53 | 18 | 187 | 98.6 | 99.3 |
| Example 8 | 2.51 | 13 | 187 | 98.3 | 99.0 |
| Example 9 | 2.52 | 14 | 185 | 98.1 | 98.9 |
| Comparative | 2.48 | 22 | 179 | 98.5 | 97.8 |
| Example 1 | | | | | |
| Comparative | 2.47 | 28 | 183 | 98.4 | 97.1 |
| Example 2 | | | | | |
| Comparative | 2.45 | 10 | 173 | 97.1 | 96.6 |
| Example 3 | | | | | |
| Comparative | 2.38 | 20 | 182 | 93.9 | 90.2 |
| Example 4 | | | | | |

According to the cathode material prepared in the present disclosure, an intermediate solution including a lithium source, an iron source, a transition metal salt source, a bismuth source, and a solvent is subjected to a hydrothermal reaction and heat treatment to prepare a core including lithium iron phosphate and a bismuth salt, and at least part of the lithium iron phosphate and the bismuth salt are connected by chemical bonds, so that the core has excellent tap density, resulting in excellent energy density and first efficiency. As can be seen from Table 1, capacities of the cathode materials in Example 1 to Example 9 at 0.1C can reach more than 185 mAh/g, up to 189 mAh/g, and the first efficiency can reach 98.1%, up to 98.7%, which are significantly higher than the cathode materials prepared in Comparative Example 1 to Comparative Example 4. Moreover, in the core of the present disclosure, the lithium iron phosphate and the bismuth salt are connected by chemical bonds, and a surface of the core is provided with a conductive polymer coating layer, so that the cathode material has excellent structural stability and conductivity, which can reduce structural changes caused by volume changes of the cathode material during the charging and discharging, thereby prolonging the cycle life of the cathode material applied to the secondary battery. The cathode materials in Example 1 to Example 9 undergoing a 300-cycle electrical performance test, a capacity retention rate thereof can reach 89.8%, up to 99.4%, which are significantly better than the cathode materials prepared in Comparative Example 1 to Comparative Example 4. As can be seen, the cathode material prepared with the preparation method in the present disclosure can improve capacity performance and first efficiency of the cathode material and prolong the cycle life, which provides a new solution for improving comprehensive electrochemical performance of the cathode material.

In Example 1 to Example 7, by changing an addition ratio of the lithium source, the iron source, the transition metal salt source, the bismuth source, to the solvent and a hydrothermal reaction condition and ensuring that the above process parameters are controlled within the defined range of the present disclosure, a cathode material with good capacity performance, first efficiency, and cycle life can be prepared.

In Example 1, Example 8, and Example 9, by using different transition metal salt sources to participate in hydrothermal reactions, different bismuth salts are generated. Bismuth tungstate is generated in Example 1, Bismuth molybdate is generated in Example 8, and Bismuth vanadate is generated in Example 9. The tap density of the cathode materials prepared in Example 8 and Example 9 decreases slightly, so that the 300-cycle capacity retention rates of the cathode materials prepared in Example 8 and Example 9 were comparable and less than that of the cathode material prepared in Example 1. In addition, the chemical stability of Bismuth vanadate is not as good as that of Bismuth tungstate and Bismuth molybdate, resulting in slightly worse capacity and first efficiency of the cathode material prepared in Example 9. Bismuth tungstate is taken as the core of the cathode material, which has optimal tap density and structural stability, and comprehensive performance thereof reaches an optimal state.

In the cathode material prepared in Comparative Example 1, Bismuth tungstate is taken as a coating layer. By comparing Comparative Example 1 with Example 1, the cathode material in Comparative Example 1 has lower tap density and higher electrical resistivity, which affects energy density of the cathode material prepared into the battery. Moreover, the higher electrical resistivity causes the battery, to which the cathode material is applied, to generate more heat during the charging and discharging, causing thermal stress and annealing of the material structure, resulting in a reduction in the capacity retention rate of the material, and further leading to a reduction in the cycle life of the battery.

In the cathode material prepared in Comparative Example 2, the cathode material includes only a compound of lithium iron phosphate and Bismuth tungstate, which is not coated, resulting in excessive electrical resistivity of the cathode material and decreased conductivity of the material, and resulting in large volume expansion of the battery to which the cathode material is applied during the charging and discharging and poor cycle performance.

In the cathode material prepared in Comparative Example 3, the core is only one kind of lithium iron phosphate, which results in a reduction in the tap density of the material, leading to poor capacity performance, low first efficiency, and poor high-and-low temperature performance. Moreover, when the cathode material with lower tap density is applied to the battery, uniformity of the volume changes during the charging and discharging is worse, which leads to an increase in stress of the cathode material, thereby affecting cycle stability of the battery.

The cathode material prepared in Comparative Example 4 is a physical mixture of lithium iron phosphate, Bismuth tungstate, and polyaniline, and the tap density of the cathode material is excessively low. As a result, the first efficiency and the capacity retention rate of the cathode material are much lower than those of the cathode material in the present disclosure.

The applicant states that the present disclosure illustrates the detailed process equipment and the process flow of the present disclosure through the above embodiments, but the present disclosure is not limited to the detailed process equipment and the process flow above, which does not mean that the present disclosure must depend on the detailed process equipment and the process flow above for implementation. Those skilled in the art should know that any improvement to the present disclosure, equivalent replacement to each raw material of the product of the present disclosure, addition of auxiliary components, selection of specific manners, and the like shall fall within the protection scope and the disclosure scope of the present disclosure.

What is claimed is:

1. A method for preparing a secondary battery, comprising:
mixing a lithium source, an iron source, a phosphorus source, a transition metal salt source, a bismuth source, and a solvent to obtain an intermediate solution having a pH ranging from 1.0 to 4.0;
subjecting the intermediate solution to a hydrothermal reaction to obtain a product, and drying the product to obtain a precursor;
subjecting the precursor to heat treatment to obtain a core, wherein the core comprises lithium iron phosphate and a bismuth salt;
coating the core with a coating material to obtain a cathode material, wherein the cathode material comprises the core and a conductive polymer coating layer arranged on at least a surface of the core;
coating a cathode current collector with the cathode material to obtain a cathode plate by rolling;
coating an anode current collector with an anode material to obtain an anode plate by rolling;
winding the cathode plate, the anode plate, and a separator to obtain a wound cell;
assembling the wound cell to obtain a battery module; and
injecting an electrolyte into the battery module to obtain the secondary battery.

2. The method according to claim 1, wherein the mixing the lithium source, the iron source, the phosphorus source, the transition metal salt source, the bismuth source, and the solvent to obtain the intermediate solution comprises:
mixing the lithium source, the phosphorus source, the iron source, and the solvent to obtain a mixed solution comprising the phosphorus source, the lithium source, and the iron source; and
adding the transition metal salt source and the bismuth source to the mixed solution, and adding an acid solution to obtain the intermediate solution.

3. The method according to claim 1, wherein a molar ratio of the phosphorus source, the lithium source, the iron source, to the bismuth source is (1.0 to 1.15):(1.0 to 1.15): 1:(0.01 to 0.03).

4. The method according to claim 1, wherein a molar ratio of the transition metal salt source to the bismuth source is (2.0 to 2.15):1.

5. The method according to claim 1, wherein the phosphorus source comprises at least one of iron phosphate, ammonium monohydrogen phosphate, ammonium dihydrogen phosphate, ammonium phosphate, or ferrous monohydrogen phosphate.

6. The method according to claim 1, wherein the lithium source comprises at least one of lithium carbonate, lithium phosphate, lithium hydroxide, or lithium chloride.

7. The method according to claim 1, wherein the iron source comprises a soluble iron salt, and
wherein the iron source further comprises at least one of ferrous sulfate, ferric nitrate, ferric chloride, ferric sulfate, or ferric oxalate.

8. The method according to claim 1, wherein the transition metal salt source comprises at least one of a tungsten source, a molybdenum source, or a vanadium source,
wherein the tungsten source comprises at least one of sodium tungstate, ammonium tungstate, or calcium tungstate,
wherein the molybdenum source comprises at least one of sodium molybdate or ammonium molybdate, and
wherein the vanadium source comprises at least one of ammonium metavanadate or vanadic acid.

9. The method according to claim 1, wherein the bismuth source comprises an other bismuth salt, the other bismuth salt comprises at least one of bismuth nitrate, bismuth oxide, or bismuth chloride.

10. The method according to claim 1, wherein the solvent comprises at least one of water, ethylene glycol, or anhydrous ethanol.

11. The method according to claim 1, wherein an amount of the solvent to be added ranges from 120 ml to 200 ml.

12. The method according to claim 1, wherein a temperature of the hydrothermal reaction ranges from 140° C. to 200° C., and/or
wherein a duration time of the hydrothermal reaction ranges from 12 h to 20 h.

13. The method according to claim 1, wherein a temperature of the heat treatment ranges from 400° C. to 800° C., and/or
wherein a duration time of the heat treatment ranges from 3 h to 8 h.

14. The method according to claim 1, wherein the coating the core with the coating material comprises mixing a polymer monomer, an oxidant, and the core.

15. The method according to claim 14,
wherein:
the polymer monomer comprises at least one of aniline, pyrrole, amide, acrylic acid, or ethylene oxide; and/or
the oxidant comprises at least one of persulfate, hydrogen peroxide, or potassium dichromate; and/or
a molar ratio of the polymer monomer to the core is (2 to 8): 1; and/or
a molar ratio of the polymer monomer to the oxidant is 1:(0.2 to 0.8).

16. The method according to claim 14, wherein a temperature of the mixing the polymer monomer, the oxidant, and the core ranges from 0° C. to 5° C., and/or
wherein a duration time of the mixing the polymer monomer, the oxidant, and the core ranges from 4 h to 8 h.

17. The method according to claim 1, wherein the secondary battery comprises:
the cathode plate;
the anode plate;
the separator; and
the electrolyte,
wherein the cathode plate comprises the cathode current collector and the cathode material arranged on at least one surface of the cathode current collector, and
wherein the cathode material comprises the core and a coating layer distributed on at least part of a surface of the core, at least part of the lithium iron phosphate and the bismuth salt are connected by a chemical bond, and a material of the coating layer comprises a conductive polymer.

18. The method according to claim 17, wherein an average diameter of the lithium iron phosphate is greater than an average diameter of the bismuth salt, and
wherein the average diameter of the lithium iron phosphate ranges from 3 μm to 5 μm, and the average diameter of the bismuth salt ranges from 1 μm to 2 μm.

19. The method according to claim 17, wherein the bismuth salt comprises at least one of bismuth tungstate, bismuth molybdate, or bismuth vanadate, and/or
wherein the conductive polymer comprises at least one of polyaniline, polypyrrole, polyamide, polyacrylic acid, or polyethylene oxide.

20. The method according to claim 17, wherein a morphology of the lithium iron phosphate is spheroidal, and/or
wherein a morphology of the bismuth salt is at least one of a flower shape, a line shape, a nest shape, or a plate shape, and/or
wherein a molar ratio of the lithium iron phosphate to the bismuth salt is 100:(1 to 3), and/or
wherein a tap density of the cathode material ranges from 2.5 g/cm³ to 2.6 g/cm³, and/or
wherein an electrical resistivity of the cathode material ranges from 10 Ω·m to 20 Ω·m.
